(19) United States
(12) Patent Application Publication
(10) Pub. No.: US 2026/0350705 A1
(43) Pub. Date: Nov. 5, 2026

(54) CUSTOMIZED VIRTUAL AGENT MANAGEMENT

(71) Applicant: Wells Fargo Bank, N.A., San Francisco, CA (US)

(72) Inventors: Ramya Balasubramanian, Secunderabad (IN); Rameshchandra B. Ketharaju, Hyderabad (IN); Gulshan Kumar, Bhagalpur (IN)

(21) Appl. No.: 19/195,852

(22) Filed: May 1, 2025

(51) Int. Cl. G06Q 40/06

(52) U.S. Cl. CPC G06Q 40/06

(57) ABSTRACT

An example method for managing virtual agents includes receiving first user data from a first user device associated with a first user account. The method further includes providing the first user data to a large language model and outputting, by the large language model, a first virtual agent corresponding to the first user account. The method further includes receiving a request to provide the first virtual agent to a second user device, receiving, from the second user device, an influence factor, and providing the first virtual agent to the second user device to process queries according to the influence factor.

### BACKGROUND

Many people use some form of a financial institution, such as a bank, to store and manage their money. Traditional banks offered storage and payment services; however, many have begun offering financial investment advice as well. Not only can a user safely store their money at the financial institution, but they can also access expert investing advice. For example, physical agents of a financial institution can inform a customer of possible investment strategies that meet their goals.

With the rise of automation, mobile applications have added features that include automating financial management. These mobile applications can receive input and provide options for the customer to update their investment portfolio, such as buying stocks, index funds, selling stocks, or other investment activities.

### SUMMARY

Examples provided herein are directed to managing virtual agents.

According to one aspect, an example method for managing virtual agents includes receiving first user data from a first user device associated with a first user account. The first user data includes at least one of profile data, behavior data, and spending data. The method further includes providing the first user data to a large language model and outputting, by the large language model, a first virtual agent corresponding to the first user account. The first virtual agent encodes behaviors associated with the first user account and based on the first user data. The method further includes receiving a request to provide the first virtual agent to a second user device, receiving, from the second user device, an influence factor indicating a percentage of processing to be performed by the first virtual agent and a percentage of processing to be performed by a second virtual agent for queries received by the second user device, and providing the first virtual agent to the second user device to process queries according to the influence factor.

According to another aspect, an example method for managing virtual agents includes receiving first user data from a first user device associated with a first user account. The first user data includes profile data, behavior data, or spending data. The method further includes providing the first user data to a large language model and outputting, by the large language model, a first virtual agent corresponding to the first user account. The first virtual agent encodes behaviors associated with the first user account. The method further includes receiving a request to provide the first virtual agent to a second user device. The second user device is associated with a second user account of a second user who is in the same family as a first user of the first user account. The method further includes receiving updates to a rule set of the first virtual agent and updating the first virtual agent on the second user device with the updates.

According to an additional aspect, an example system for managing virtual agents includes a server device including one or more processors and one or more memory devices. The one or more memory devices include instructions that, when executed by the one or more processors, cause the server device to provide first user data associated with a first user account to a large language model and generate, using the large language model, a first virtual agent corresponding to the first user account. The first virtual agent encodes behaviors associated with the first user account and based on the first user data. The server device is further caused to send the first virtual agent to another device responsive to receiving a request for access to the first virtual agent. The system further includes a user device including second one or more processors and second one or more memory devices. The second one or more memory devices include second instructions that, when executed by the second one or more processors, cause the user device to receive the first virtual agent from the server device receive input indicating an influence factor indicating a percentage of processing to be performed by the first virtual agent and a percentage of processing to be performed by a second virtual agent for queries received from a user, receive a query; and process the query using the first virtual agent and the second virtual agent according to the influence factor.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for managing virtual agents.

FIG. 2 shows an additional embodiment of the system of FIG. 1.

FIG. 3 shows an additional embodiment of the system of FIG. 1.

FIG. 4 shows an additional embodiment of the system of FIG. 1.

FIG. 5 shows example logical components of a server device of the system of FIG. 1.

FIG. 6 shows an example method for managing virtual agents that can be performed by the system of FIG. 1.

FIG. 7 shows an additional example method for managing virtual agents that can be performed by the system of FIG. 1.

FIG. 8 shows an additional example method for managing virtual agents that can be performed by the system of FIG. 1.

FIG. 9 shows an example graphical user interface that can be displayed on a client device of the system of FIG. 1.

FIG. 10 shows example physical components of a computing device of the system of FIG. 1.

### DETAILED DESCRIPTION

This disclosure relates to customized virtual agent management.

Mobile applications that provide virtual agents for managing finances have increased in popularity. These virtual agents can provide expert advice to a user through their mobile device. A user can download a mobile application affiliated with a financial institution on to their mobile device, then the user can ask the virtual agent questions as if they were talking to a live expert. The virtual agent is configured to respond with accurate answers that can help the user. The responses of the virtual agent may be based on user preferences, user settings, and/or the agent may ask questions to determine the investment strategy for the user. These virtual agents are often impersonal and offer no customization for the user. Further, the virtual agents may lack expertise in investments. Also, the provided investment advice or functions are generic and not suited for any one user's lifestyle. The investment advice lacks the underlying knowledge of experts that are known for making good investments.

The present disclosure provides a system and methods for management of virtual agents that are configured to learn from user data and offer a personalized investment experience. The system obtains user data associated with the user account and generates a virtual agent corresponding to the user account. The virtual agent receives queries from the user and then provides output that is tailored to the user. The virtual agent has been trained on the user data to enable personalized advice. In some embodiments, the virtual agent manages banking and investments for the user. Further, specialized virtual agents can be trained on high-net-worth individuals that are known for their expertise in investing.

As provided herein, a “virtual agent” is an autonomous artificial intelligence (AI) entity that is responsible for deciding the steps to take for a given task. In some embodiments, the virtual agent is powered by a large language model (LLM) and is programmed to receive a prompt. The prompt contains information that the virtual agent can use to craft a response. The virtual agent can respond with human-like responses to the queries using the LLM. In some examples, the virtual agent can access additional tools or applications and perform specified tasks such as solving a math problem or writing code.

To generate the virtual agent, user data is provided to a machine learning model, such as the LLM. The machine learning model processes the user data and outputs the virtual agent that corresponds to the user profile. In some embodiments, the user data is provided as embeddings to the LLM. The virtual agent can then be stored in a virtual agent database and/or provided to the user device for processing user queries. Once a query is received, the virtual agent provides a customized response that is based on the past behavior of the user. The response displays on the user device and includes investment strategies for the user.

Embeddings are vectors (lists of numbers) that represent the meaning of words, phrases, or even entire documents. These vectors are designed so that items with similar meanings have similar vector representations (i.e., they are close to each other in the vector space). LLMs use embeddings to understand the relationships between different pieces of text. Further, embeddings also capture the context and relationship between tokens. This allows the LLM to understand the context and nuances of language. Further, LLMs use embeddings to process and understand input text, and to generate coherent and relevant output. Tokens are units that are processed by LLMs. A prompt with natural language words is broken down into smaller pieces that are represented by numbers, which are called tokens. This process is called “tokenization.” Tokenization converts text into a numerical representation that the model can understand. Tokens can be words, parts of words, individual characters, or punctation marks.

The virtual agent may learn from user data such as profile data, behavior data, and/or spending data. For example, the virtual agent may learn from past investment decisions of the user. In some embodiments, the virtual agent learns from spending habits of the user. Based on this additional user data, the virtual agent can alter its behavior to match the updated user data.

In some embodiments, a high-net-worth individual (HNI) interacts with their mobile device to develop an investment strategy. The HNI may select stocks, funds, or other investment vehicles to invest their money. The system can then track the generated user data from the investment strategy developed by the HNI user. Using this user data, the system can use the machine learning model to generate the virtual agent that corresponds to the HNI. In some embodiments, the machine learning model programs the virtual agent using the user data as embeddings. The virtual agent then answers queries as the HNI user would with the same behavior.

The system can also store the virtual agents in a database. The database can contain a number of virtual agents that can be sent to user devices. Each of the virtual agents may correspond to a different user and provide investment advice that mimics the corresponding behavior of the user. That is, the investment advice would be as if the actual person was providing the advice. Other user devices may then request a specific virtual agent for download. The other user devices can then ask the downloaded virtual agent for financial or investment advice.

In some embodiments, the virtual agent of a first user account can be provided to user accounts that are members of a group. The group of user accounts may be a family of users. The first user account may be associated with an HNI that wishes to share their knowledge to their group members or manage the finances of the group members. After authenticating members as part of the group, the system can provide copies of the virtual agent of the first user account to user devices associated with member user accounts. The first user can then input rule sets or limits for the virtual agent of the first user account. For example, the virtual agent can receive a spending limit for one or more members of the group.

In some embodiments, a corpus dataset stores the first user data. For example, the corpus dataset can store the first user data as embeddings. Members of the family group can then access the corpus dataset to obtain the first user data at any time. When the corpus dataset is accessed, a virtual agent of the group member can receive the first user data to use for processing queries. As a result, a user account that is a member of the group can indefinitely access financial knowledge of other group members. For example, the first user data may be associated with a father. A user account associated with a child can access the user data of the father stored in the corpus dataset to have queries answered as the child's father would. The system maintains the corpus dataset for future generations to access the knowledge base. In some examples, the first user data is provided as embeddings to the requesting virtual agent of the group member to add context to any query input into the virtual agent of the group member. The system is configured with additional features as well.

The system improves the management of virtual agents by generating virtual agents that more closely match behavior data obtained from a client device. Rather than generic virtual agents that provide the same response to every requesting device, these virtual agents learn from user data. Further, the user data is used as context when processing queries, so the responses are more customized to the user. In addition, the user data from one client device can be used as context at a second client device. So, when the second client device processes queries, it can respond with the context of the first client device. Additionally, virtual agents can limit other client devices spending or other actions. User data is also stored as embeddings for access later. These features improve the quality of responses that virtual agents are able to provide.

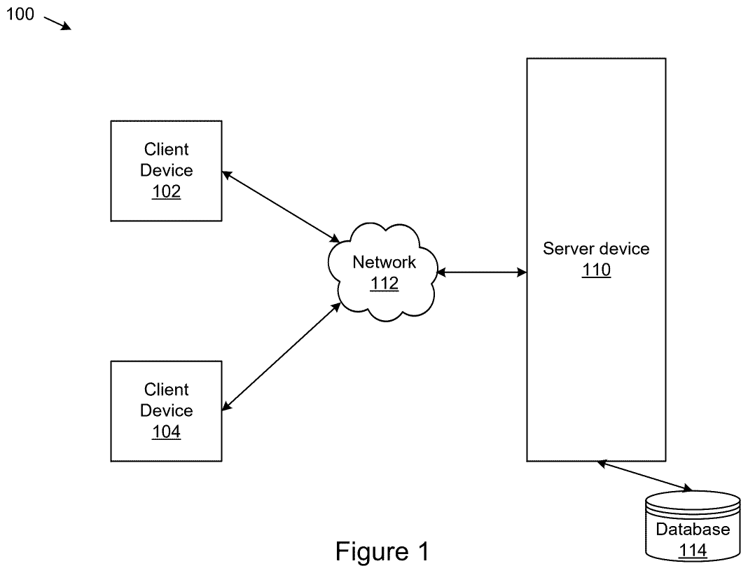

FIG. 1 schematically shows aspects of one example system 100 programmed to manage virtual agents. In this example, the system 100 can be a computing environment that includes a plurality of client and server devices. In this instance, the system 100 includes client devices 102, 104, a server device 110, and a database 114. The client devices 102, 104 can communicate with the server device 110 through a network 112 to accomplish the functionality described herein.

The server device 110 manages generation and storage of virtual agents. Also, the server device 110 receives data from the client device 102 and the client device 104 to generate the virtual agents that correspond to user accounts of the client device 102 and the client device 104. Then, the server device 110 can provide each corresponding virtual agent to the client device 102 and the client device 104. The virtual agents can also be stored in the database 114 for later access. The server device 110 can also copy the virtual agent of the client device 102 and provide it to the client device 104.

In some embodiments, the server device 110 may include machine learning models to generate the virtual agents. The machine learning model may classify user accounts for matching with a virtual agent that has similar behaviors embedded as user data of the user account. In some embodiments, an LLM is used to program virtual agents. Once generated, the virtual agents are ready for answering queries that are input into the client device 102 and the client device 104.

The LLM may be an artificial intelligence (AI) designed to understand and generate human-like text, images, videos, or other items. LLMs are trained on massive datasets of text and code, allowing them to recognize patterns, relationships, and nuances in language. They can process and interpret the meaning of words, phrases, and sentences within a given context. In some embodiments, the LLMs utilize deep learning techniques, such as transformer networks, which are designed to handle sequential data like text. For example, the LLM can be a neural network.

The server device 110 may offer other features as well. These features may include managing groups of user accounts and maintaining corpus datasets of user data. For example, the server device 110 can group the user account associated with the client device 102 with the user account associated with the client device 104. Also, user data from the client device 102 and user data from the client device 104 can also be stored in a corpus dataset of the user data.

In some embodiments, the server device 110 accesses third-party devices through the network 112. For example, a third-party device may store an LLM that is used to generate virtual agents. The server device 110 may access the LLM through an application programming interface (“API”). The third-party device may provide other services, such as exchanging data to the server device 110, as well.

The client device 102 and the client device 104 can be user devices that are used to access the features of the server device 110. The client device 102 and the client device 104 may be a computer, a mobile device, tablet, or other processing device. Each of the client device 102 and the client device 104 may include an application that accesses the server device 110. For example, the client device 102 and the client device 104 may download a client-side application that accesses the functions of the server device 110. They may include standard computing components, such as a processor and memory.

The database 114 stores user data and the virtual agents associated with user profiles. In some embodiments, the database 114 stores scores associated with each virtual agent. Further, the database 114 may store corpus datasets associated with the user account or the group of user accounts. In some embodiments, the scores of the virtual agents are based on quality of advice, investment decisions, portfolio returns, net worth of HNI, and/or other criteria.

In some embodiments, the database 114 may be a relational database that stores structured data, such as a structured-query language (SQL) database. The database can also be an unstructured-data database that is a NoSQL database such as Mongo DB. The database may be stored locally with the server device 110 or in the cloud at a remote location. Further, the database 114 may be other types of databases such as object-oriented, graph, in-memory, or columnar.

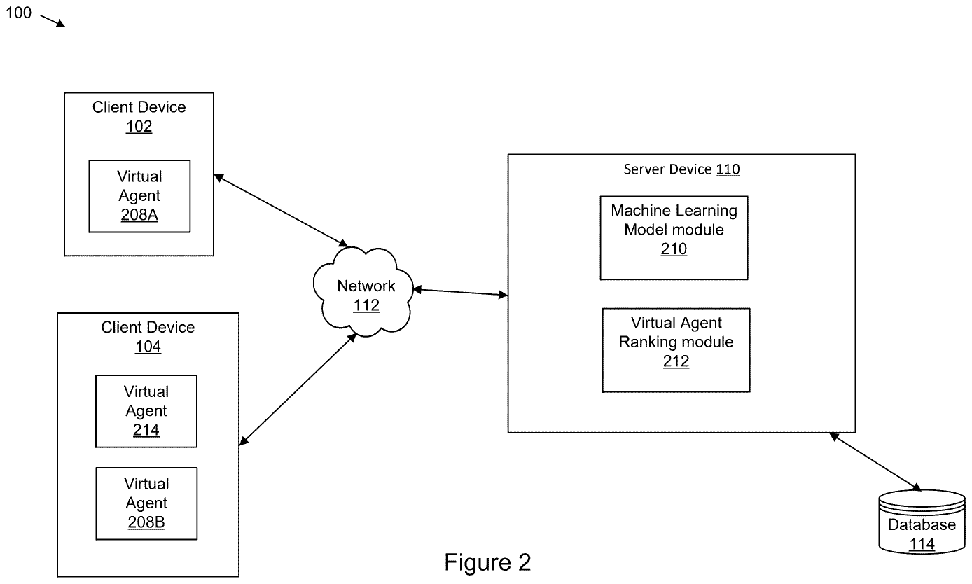

FIG. 2 shows an additional embodiment of the system 100. The server device 110 includes a machine learning model module 210 and a virtual agent ranking module 212. The client device 102 includes a virtual agent 208A. The client device 104 includes a virtual agent 208B and a virtual agent 214.

The machine learning model module 210 generates the virtual agent 208A. In some embodiments, the machine learning model module 210 includes an LLM to program the virtual agent 208A, the virtual agent 208B, and the virtual agent 214. Also, the machine learning model module 210 may include a k-means clustering algorithm model. This model may be used to categorize the user account associated with the client device 102 and the user account associated with the client device 104. The machine learning model module 210 can assign virtual agents that include programming or context that is similar to the user data associated with the user account associated with the client device 102 and the user data associated user account associated with the client device 104. In some embodiments, a different generation process is used. In some embodiments, the virtual agent 208A is embedded on the client device 102.

In some embodiments, the machine learning model module 210 also copies the virtual agent 208A and generates the virtual agent 208B. The virtual agent 208B includes the same programming to process queries as the virtual agent 208A. Even though the virtual agent 208B is stored on the client device 104, the virtual agent 208B processes queries with context based on the user data of the client device 102. For example, the client device 104 can process a query received as input using the virtual agent 208B. The answer will be as if it is from the user of the client device 102 or a similar response since the virtual agent 208B is a copy of the virtual agent 208A that was trained on user data of the client device 102.

For example, the machine learning model module 210 assigns the virtual agent 208A to the user account associated with the client device 102. The machine learning model module 210 then trains the virtual agent 208A on the user data of the client device 102. The virtual agent 208A includes programming to process queries with a similar behavior to the user of the client device 102. In some embodiments, the virtual agent 208A encodes behaviors associated with the user account of the client device 102. The similar behavior may include similar financial decisions, investment decisions, or as context when processing queries. For example, the virtual agent can recommend stocks that the user should buy. These stocks would be the same as would be recommended by the user of the client device 102. Also, the behaviors can include recommendations on cuts to spending categories as would be recommended by the user of the client device 102. In some embodiments, the embeddings are provided as context to affect the underlying layers of the virtual agent 208A. The virtual agent 208A can also be stored in the database 114.

The machine learning model module performs a similar process to generate the virtual agent 214. The virtual agent 214 is trained on user data associated with the user account of the client device 104. In some embodiments, the virtual agent 214 processes queries based on the user data of the client device 104 and answers the queries in line with a similar behavior as the user of the client device 104. The virtual agent 214 encodes the behavior of the user of the client device 104. Also, the virtual agent 214 responds to queries as the user of the client device 104 would. In some embodiments, the virtual agent 208B and the virtual agent 214 are embedded on the client device 104.

The client device 104 utilizes both the virtual agent 214 and the virtual agent 208B for processing queries. The virtual agent 214 and the virtual agent 208B can process received queries in a variety of ways. In some embodiments, the client device 104 receives an influence factor. The influence factor indicates a percentage of processing to be performed by the virtual agent 208B and a percentage of processing to be performed by the virtual agent 214 for queries received by the client device 104. In some embodiments, the influence factor indicates a first number of tokens that the virtual agent 208B processes and a second number of tokens that the virtual agent 214 processes. For example, the client device 104 may receive a query about investment advice. The virtual agent 214 processes 20% of the tokens of the received query while the virtual agent 208B processes 80% of the tokens of the received query.

For example, a query of “Provide good long-term investments” may be converted into tokens. In some embodiments, a percentage of the tokens are processed by the virtual agent 208B while a second percentage of the tokens are processed in parallel by the virtual agent 214. In some embodiments, the tasks of providing a response are split up. For example, the virtual agent 214 may handle tokenization and linguistic analysis while the virtual agent 208B handles searching its knowledge base and generating a natural language answer.

In some embodiments, selecting an influence factor can affect the cost of using the virtual agent 208B. For example, cost of using the virtual agent 208B increases as the influence factor increases. A predetermined cost for handling queries, may be multiplied by the influence factor to arrive at the cost. In an example, the cost per query is $1.00 and the influence factor for the virtual agent 208B is set to 60%. The cost for processing the query using the virtual agent 208B is then $0.60. This example is merely illustrative, and other cost models can be used.

In some embodiments, the virtual agent 208B and the virtual agent 214 process queries based on the type of query that the client device 104 receives. For example, if the received query is an account management type, then the virtual agent 214 processes the query. If the received query is an investment advice type, then the virtual agent 208B processes the query. In some embodiments, the virtual agent 214 determines the type of query received by the client device 104, such as a classification. Responsive to a determination that the classification of the query is an investment query, the virtual agent 208B processes the query. In some embodiments, the classification is determined to be a user account query, which the virtual agent 214 processes. The virtual agent 214 may process the user account query without passing it to the virtual agent 208B.

Further, in some embodiments, the server device 110 provide a code to the client device 104 for scanning to access the virtual agent 208B. The code may be a quick response (QR) code that can verify the client device 104 as being authenticated and authorized to access the virtual agent 208B. Once scanned, the server device 110 provides the virtual agent 208B to the client device 104.

In some embodiments, the server device 110 can provide a plurality of codes that each correspond to a different virtual agent stored in the database 114. In some embodiments, the server device 110 receives a request to disable the virtual agent 208B. The user may wish to disable the virtual agent 208B due to not wanting to pay for access anymore. In some embodiments, once the user has ended their subscription, the client device 104 sends a request to disable the virtual agent 208B. Responsive to receiving the request, the server device 110 deletes the virtual agent 208B, such as by sending a command to the client device 104 to remove the virtual agent 208B. In some embodiments, a request is processed by both the virtual agent 214 and the virtual agent 208B and a second request is processed by the virtual agent 214 and not the virtual agent 208B. Further, the client device 104 may receive input to disable the virtual agent 208B. Responsive to the input, the client device 104 deletes the virtual agent 208B to prevent it from processing queries. When the virtual agent 208B is deleted, it is removed from the client device 104 and can no longer process queries.

In some embodiments, a third client device connects to the server device 110. Similar functions are used to generate a third virtual agent that is stored in the database 114. The third client device may also be associated with an HNI. The third virtual agent can then be stored in the database 114 and offered for download by other individuals.

The virtual agent ranking module 212 ranks stored virtual agents in the database 114. The rankings may be based on a number of downloads or ratings associated with each virtual agent. For example, the virtual agent 208A may receive virtual agent statistics such as many positive reviews or a substantial number of downloads. The virtual agent ranking module 212 tracks the statistics for each virtual agent and determines a rating. In an example, the virtual agent ranks the virtual agent with a high ranking, such as number one of the virtual agents in the database 114. The ranking may also be a rating of a star count, such as five out of five stars. In some embodiments, the rankings are scores based on quality of advice, investment decisions, portfolio returns, net worth of a HNI, and/or other criteria. In some embodiments, the virtual agent ranking module 212 rates the stored virtual agents based a number of requests for access to each of the virtual agents.

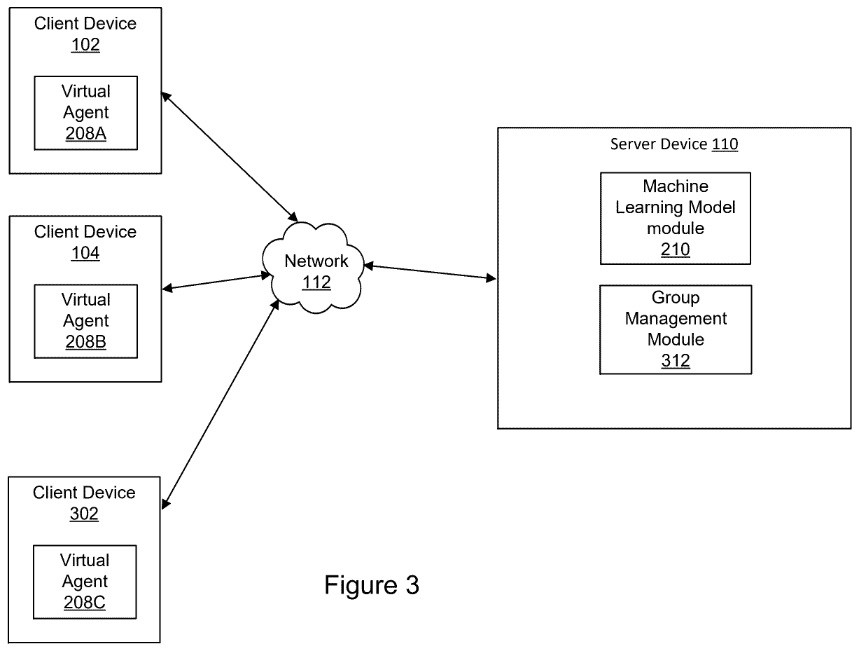

FIG. 3 shows an additional embodiment of the system 100. In the shown embodiment, the system 100 includes a client device 302. Also, the client device 302 connects to the server device 110 through the network 112. The client device 302 includes a virtual agent 208C. Further, the server device 110 includes a group management module 312.

The client device 102 and the client device 104 may perform the same or similar functions as previously described. Further, the virtual agent 208C may be generated using the same or similar processes to generate the virtual agent 208B by using the machine learning model module 210. Further, the client device 302 has an associated user account. In some embodiments, the client device 104 and the client device 302 include additional virtual agents, such as the virtual agent 214.

In some embodiments, the group management module 312 groups the user account associated with the client device 102, the user account associated with the client device 104, and the user account associated with the client device 302 into a group of user accounts. The group may be a family. For example, the user of the client device 102, the client device 104, and the client device 302 may all be related. Further, the user of the client device 102 may wish to manage the spending or investing of the client device 104 and the client device 302.

The server device 110 generates the virtual agent 208B and the virtual agent 208C to be copies as of the virtual agent 208A. Both the virtual agent 208B and the virtual agent 208C process queries using the user data associated with the client device 102. In some embodiments, the virtual agent 208B and the virtual agent 208C are part of the same group.

To manage the spending of the virtual agent 208B and the virtual agent 208C, the server device 110 includes a rule set with the virtual agent 208B and the virtual agent 208C. The rule set may include a control (also referred to as a lock) with the virtual agent 208B and the virtual agent 208C. The rule set may be a LLM safety measure that directs the virtual agent to perform certain tasks when it detects the prompt/query falls within the rule set. For example, the virtual agent may include a component to generate a probability that the prompt falls within the rule set. If the probability exceeds a predetermined threshold, the LLM defaults to a response, such as not performing the action requested in the prompt.

The rule set may be a limit on transactions. For example, the client device 102 may receive a limit on the transactions for the user account associated with the client device 104. The server device 110 implements the limit within a rule set for the virtual agent 208B. The server device updates the virtual agent 208B with the rule set to configure the virtual agent 208B to prevent transactions that exceed the limit on transactions. In some embodiments, the limit is on a type of transactions, such as clothes, food, or entertainment. If a payment type associated with the user account of the client device 104 attempts to make a purchase above the limit, the virtual agent 208B prevents the transaction. Preventing the transaction may include communicating with a payment system, by the virtual agent 208B to reject the transaction. In some embodiments, the rule set includes additional rules for the virtual agent 208B or the virtual agent 208C, such as other spending rules or investing rules.

In some embodiments, the server device 110 generates a code for access to copies of the virtual agent 208A. For example, the client device 104 and the client device 302 may scan a QR code. Responsive to the client device 104 and the client device 302 scanning the QR code, the server device 110 provides the virtual agent 208B to the client device 104 and the virtual agent 208C to the client device 302. Further, the group management module 312 assigns the user account associated with the client device 104 and the user account associated with the client device 302 to the same group as the user account associated with the client device 102.

In some embodiments, the virtual agent 208A opens a socket for group member virtual agents to connect. The virtual agent 208A is a master agent controller. The client device 104 and the client device 302 access the virtual agent 208B and the virtual agent 208C, respectively, by connecting to an open port, such as by scanning the code. The virtual agent 208B and the virtual agent 208C are then onboarded with the rule set.

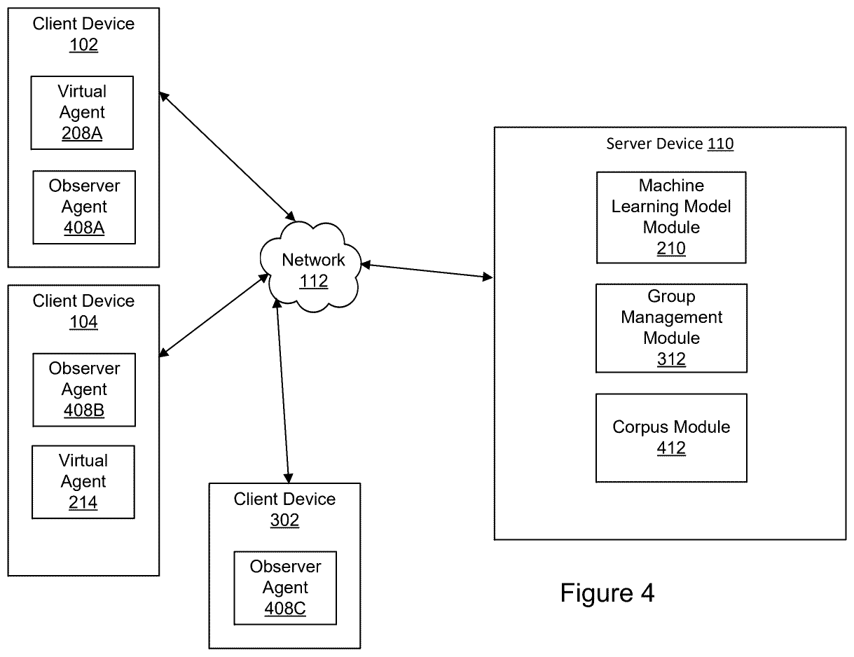

FIG. 4 shows an additional embodiment of the system of FIG. 1. In this embodiment, the client device 102 includes an observer agent 408A, the client device 104 includes an observer agent 408B, and the client device 302 includes an observer agent 408C. The server device 110 includes a corpus module 412.

The observer agent 408A monitors and collects user data from the client device 102. The observer agent 408A can then transmit the collected user data to the server device 110. In some embodiments, the observer agent 408A is a sub-agent of the virtual agent 208A. Rather than processing queries, the observer agent 408A is configured to monitor user data. Further, the observer agent 408A may also collect and process the user data and send it to the server device 110. In some embodiments, the observer agent 408A does not process queries or provide answers. Further, the observer agent 408A analyzes the user data and learns the behavior of the user associated with the client device 102.

In some embodiments, the machine learning model module 210 generates the observer agent 408A as a sub-agent of the virtual agent 208A. Further, the machine learning model module 210 produces copies of the observer agent 408A to generate the observer agent 408B and the observer agent 408C. The observer agent 408B and the observer agent 408C may be distributed to the client device 104 and the client device 302 similarly as the virtual agent 208B and the virtual agent 208C. Once the client device 104 downloads the observer agent 408B, the observer agent 408B begins collecting and analyzing the user data of the client device 104. For example, the observer agent collects user data that includes transactions, investments, and other data indicative of the behavior of the user. The observer agent 408C performs similar functions for the client device 302. The user data of the client device 104 and the user data of the client device 302 is then sent to the server device 110.

The corpus module 412 stores the user data received from the observer agent 408A, the observer agent 408B, and the observer agent 408C in a corpus dataset. The corpus dataset may be in the database 114. The corpus dataset is a collection of user data that corresponds to a behavior profile. The behavior profile indicates a behavior pattern that the user data indicates the corresponding user will likely have. In some embodiments, the corpus dataset is a cluster of data indicating the behavior pattern. Each user account may have its own corpus. In some embodiments, a group includes a corpus dataset for each user account in the group.

The corpus dataset is associated with user updates based on the received user data. For example, a corpus dataset associated with the user account of the client device 102 updates based on received user data from the observer agent 408A. Updating the corpus dataset may include updating the predicted behavior data of the corpus dataset. Each corpus dataset can be updated accordingly.

In some embodiments, the corpus dataset of the user account of the client device 102 can be accessed by different virtual agents. For example, the user of the client device 104, such as a child, may desire to know how the user of the client device 102, such as a parent, would handle a financial situation. The virtual agent 214 requests access to the corpus dataset associated with the user account of the client device 102. The server system authenticates the virtual agent 214 and allows access to the corpus dataset associated with the user account of the client device 102. In some embodiments, the corpus module 412 retrieves data from the corpus dataset in the database 114. The corpus module 412 provides the data as embeddings to the virtual agent 214 as context for processing queries. When the client device 302 receives a query, the virtual agent 214 processes the query using the received embeddings from the corpus dataset as context for processing queries. The virtual agent 214 responds to the query as user of the client device 102 would.

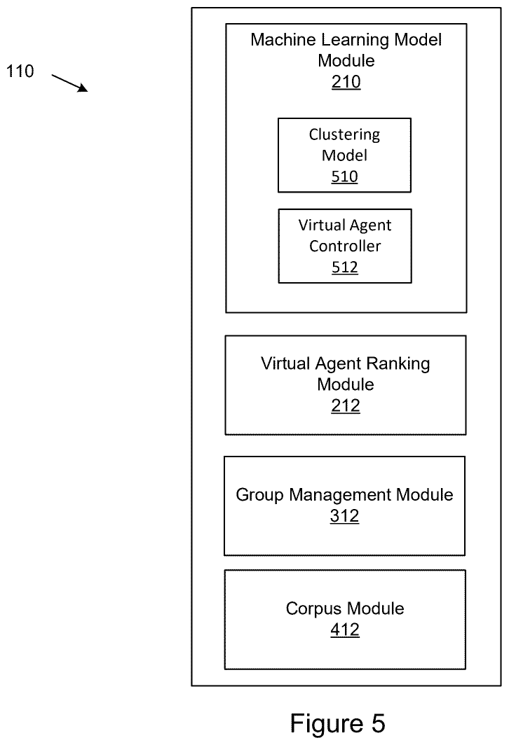

FIG. 5 shows example logical components of the server device 110 of the system 100. The server device 110 includes the machine learning model module 210, the virtual agent ranking module 212, the group management module 312, and the corpus module 412. The machine learning model module 210 includes a clustering model 510 and a virtual agent controller 512.

The clustering model 510 generates a plurality of clusters for one or more user accounts. Also, the clustering model 510 can assign additional user accounts to a cluster of the plurality of clusters. Each cluster corresponds to a behavior pattern, which may include behaviors regarding financial decisions or investment decisions. In some embodiments, the clustering model 510 includes a k-means clustering algorithm. The user data may also be received as embeddings. In some embodiments, the machine learning model module 210 includes a neural network model that captures nuanced behavior patterns to generate customer-specific embeddings.

In some embodiments, the clustering model 510 adjusts a cluster of a previously clustered user account. The clustering model 510 may receive additional data associated with the user account and adjust the user account's cluster based on the new user data. In some embodiments, each cluster is assigned a chunk token for identification. Further, the clusters may be dynamically adjusted to changes in behavior patterns.

The virtual agent controller 512 manages one or more virtual agents that are assigned to each cluster and generates the one or more virtual agents by assigning virtual agents to a user account based on the user data. As user accounts are mapped to different clusters, the virtual agent controller 512 can assign a corresponding virtual agent to the user account. The assigned virtual agent can receive user data, such as in the form of embeddings, to further align with the determined behavior pattern of the user. The virtual agent uses the received user data to train and further align with the customer behavior. The user data that is used for training may include all past queries or all queries for a given time frame. For example, the virtual agent 208A may be the assigned virtual agent for the user account of the client device 102.

In some embodiments, if the user account, based on changes in the corresponding user's behavior, begins to shift in its cluster, the virtual agent controller 512 determines whether to assign a new virtual agent to the user account. The virtual agent controller 512 may use a behavioral consistency evaluator to compare the output of a potential transfer virtual agent and the originally assigned virtual agent. Further the virtual agent controller 512 may evaluate consistency of the output of each virtual agent across parameters such as intent accuracy, tone, and response relevance. Each parameter may be assigned a weighted score as well. If the compared outputs of the potential transfer virtual agent and the originally assigned virtual agent are consistent, then the potential transfer virtual agent begins to gradually take over processing user queries. Once the user account has shifted to a different cluster, the originally assigned virtual agent is removed from the user's device and no longer processes queries. Then, the potential transfer virtual agent fully processes the queries received from the user.

In some embodiments, the virtual agent controller 512 registers assigned virtual agents on a blockchain. The blockchain may be private so that only the virtual agent controller 512 has access. Further, each virtual agent stored in the database 114 may have its own unique code stored on the blockchain. Each time the virtual agent is retrieved from the database 114, the virtual agent provides its unique code to authenticate itself to the virtual agent controller 512. Storing credentials of each virtual agent ensures malicious virtual agents generated by third parties are not allowed access to any functions of the server device 110.

In some embodiments, the machine learning model module 210 includes a LLM that is trained on user data. The LLM can may be trained on label data. Further, it may use supervised or unsupervised learning. As the LLM learns from user data, it can better program different virtual agents. Also, the output of the LLM can be compared with the desired output. After comparison, the programming (e.g., layers of the LLM) can be adjusted so the predicted output better matches the desired output. In some embodiments, the output of each virtual agent is cross verified with independent knowledge sources to ensure accuracy and prevent hallucination. Virtual agents can also be adjusted so the virtual agents produce more accurate output.

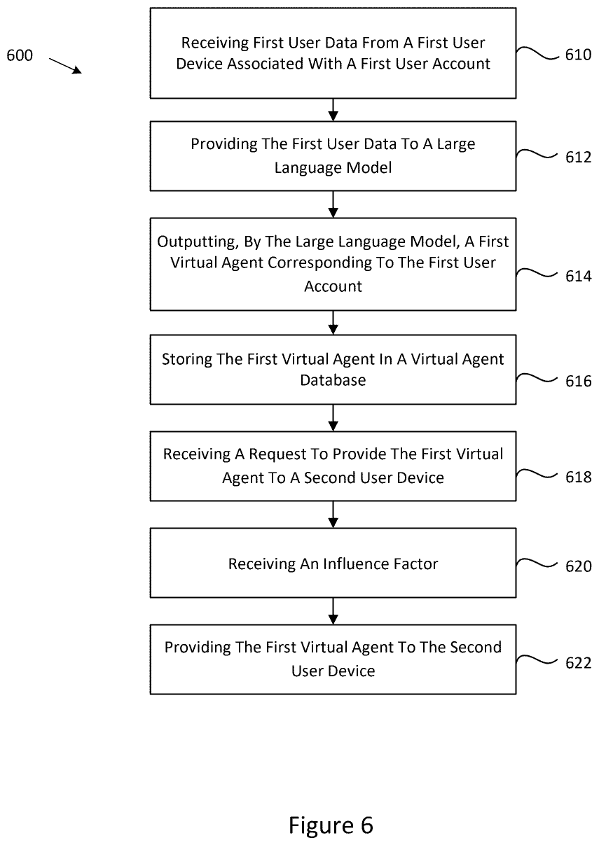

FIG. 6 shows an example method 600 for managing virtual agents that can be performed by the system 100. The method 600 includes an operation 610, an operation 612, an operation 614, an operation 616, an operation 618, an operation 618, an operation 620, and an operation 622. Some or all of the operations of the method 600 may be performed by the system 100 or any component of the system 100, such as the server device 110.

At the operation 610, first user data is received. The first user data may be received from the client device 102 by the server device 110. Further, the first user data may be associated with a first user account, such as user account of the client device 102. In some embodiments, the first user data is profile data, behavior data, and/or spending data. Further, the first user data may be converted to embeddings. The profile data may indicate demographic information of the user. The behavior data may indicate financial and investment behavior decisions, including queries, for the user. Spending data may indicate how the user has spent their money. The user data may also be for a predetermined time, such as a year, two years, or any other time frame.

At the operation 612, the first user data is provided to a large language model. For example, the first user data is provided to the machine learning model module 210. The machine learning model module 210 then processes the user data, as embeddings, to generate a first virtual agent. The first virtual agent may be the virtual agent 208A. Generating the first virtual agent may include assigning the first user account to a cluster based on the first user data. A virtual agent is assigned based on the cluster and trained on the user data.

At the operation 614, the first virtual agent is outputted by the large language model. The first virtual agent encodes behaviors associated with the first user account and based on the first user data. The first virtual agent exhibits behaviors that are similar to the user associated with the first user account. Further, it can process queries with their behavior patterns as context.

At the operation 616, the first virtual agent is stored in a virtual agent database. The virtual agent database may be the database 114. The database 114 may store a plurality of virtual agents for download. In some embodiments, each of the plurality of virtual agents have an associated rating.

At the operation 618, a request to provide the first virtual agent is received from a second user device. For example, the client device 104 is the second user device and requests the virtual agent 208A. The virtual agent 208A may be associated with a HNI, and the second user wishes to receive financial advice that would be as if the HNI provided the advice. In some embodiments, the client device 104 transmits a payment to access the virtual agent 208A. In some embodiments, the client device 104 scans a code to send a request for the virtual agent 208A.

At the operation 620, an influence factor is received. The influence factor may be received in the form of input provided to the client device 104. In some embodiments, the client device 104 then provides the influence factor to the server device 110. In some embodiments, the influence factor indicates a percentage of processing to be performed by the virtual agent 208B and a percentage of processing to be performed by the second virtual agent, such as the virtual agent 214, for queries.

At the operation 622, the first virtual agent is provided. For example, a copy of the virtual agent 208A, the virtual agent 208B, is provided to the client device 104. In some embodiments, the virtual agent 208B and the virtual agent 214 can process queries according to the influence factor.

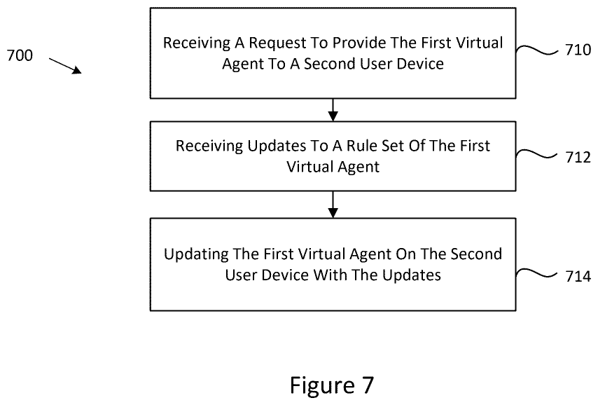

FIG. 7 shows an example method 700 for managing virtual agents that can be performed by the system 100. The method 700 includes an operation 710, an operation 712, and an operation 714. Some or all of the operations of the method 700 may be performed by the system 100 or any component of the system 100, such as the server device 110. Some or all of the operations of the method 700 may be performed in conjunction with some or all of the operations of the method 600.

At the operation 710, a request to provide the first virtual agent to a second user device is received. For example, the client device 104 may be associated with a second user account that is in the same group or family as the user account associated with the virtual agent 208A. To have access to the virtual agent 208A, the client device 104 sends the request to the server device 110. In some embodiments, the method 700 includes providing the first virtual agent to the second user device. The first virtual agent may include a rule set, such as to spending or investing.

At the operation 712, updates to a rule set of the first virtual agent are received. For example, the virtual agent 208A may have an updated rule set. The rule sent may be set to be pushed to all copies of the virtual agent 208A. The rule set may include spending limits, required periodic financial investments, or other rules.

At the operation 714, the first virtual agent is updated. The first virtual agent is copied on a second user device. For example, the virtual agent 208B receives the updates to the rule set from the server device 110. The virtual agent 208B then operations according to the rule set. In an example, if the virtual agent 208B determines a transaction is attempted that exceeds a limit, then the virtual agent 208B will deny the transaction.

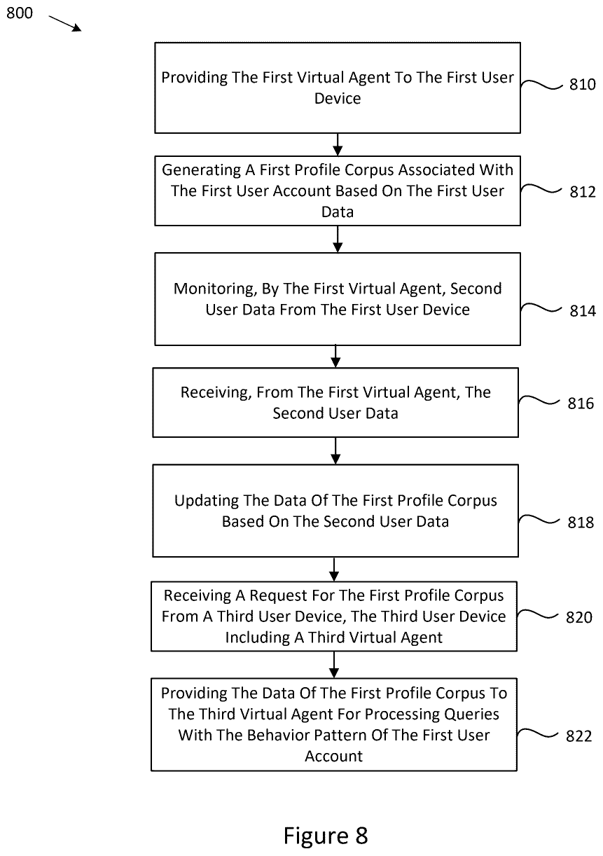

FIG. 8 shows an example method 800 for managing virtual agents that can be performed by the system 100. The method 800 includes an operation 810, an operation 812, an operation 814, an operation 816, an operation 818, an operation 820, and an operation 822. Some or all of the operations of the method 800 may be performed by the system 100 or any component of the system 100, such as the server device 110. Some or all of the operations of the method 800 may be performed in conjunction with some or all of the operations of the method 600 and/or the method 700.

At the operation 810 the first virtual agent is provided to the first user device. For example, the first virtual agent may be the observer agent 408A and the first user device is the client device 102. The observer agent 408A is configured to monitor, collect, and process user data from the client device 102. In some embodiments, the method 800 may further include providing the user data to the server device 110.

At the operation 812, a first profile corpus is generated. The first profile corpus is associated with the first user account and stores the first user data. In some embodiments, the corpus module 412 generates the first profile corpus. Also, the first profile corpus may be stored in the database 114. In some embodiments, the first profile corpus stores the first user data as embeddings.

At the operation 814, second user data is monitored by the first virtual agent. The second user data may be additional behavioral data, such as additional investments performed by the client device 102. Monitoring the second user data may include collecting and processing the second user data, such as converting to embeddings for storage in the first profile corpus.

At the operation 816, the second user data is received. For example, the server device 110 receives the second user data from the observer agent 408A on the client device 102. In some embodiments, the second user data is investing data, financial data, query data, user account data, or other kinds of user data.

At the operation 818, the first profile corpus is updated based on the second user data. Updating the first profile corpus may include updating the data of the first profile corpus. For example, a cluster of embeddings within the first profile corpus may be adjusted based on second user data.

At the operation 820, a request for access to the first profile corpus is received from a user device. For example, the client device 104 requests access to the first profile corpus. The client device 104 may be associated with a child of the parent that is associated with the first profile corpus. The child may want advice that would be as if their parent had provided the advice.

At the operation 822, the data of the first profile corpus is provided to the requesting device. The data is further provided to a virtual agent of the requesting device for processing queries with the behavior pattern of the first user account. For example, the client device 104 includes the virtual agent 214 that requests the data of the first profile corpus. The data is then provided as embeddings to the virtual agent 214. The virtual agent 214 uses the embeddings as context for processing any queries the client device 104 receives.

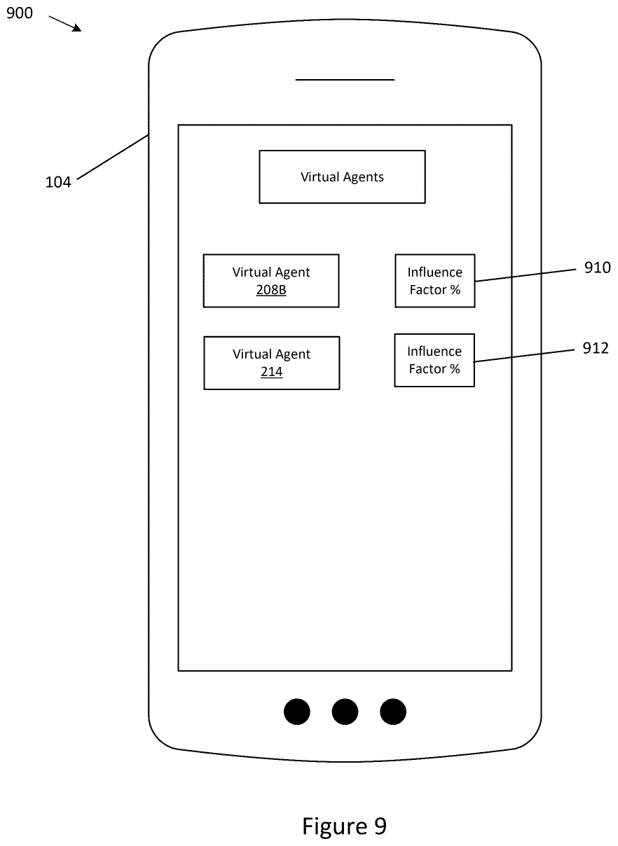

FIG. 9 shows an example graphical user interface (GUI) 900 that can be displayed on a client device 104. The GUI 900 displays the virtual agent 208B and the virtual agent 214 as selectable options. Further, the GUI 900 displays an influence factor input 910 and an influence factor input 912.

The influence factor input 910 receives input that indicates how much processing the virtual agent 208B completes of a query. Also, the influence factor input 912 receives input that indicates how much processing the virtual agent 214 completes of a query. For example, the influence factor input 910 receives “80” and the influence factor input 912 receives “20” as respective inputs. As a result, the virtual agent 208B processes 80% of the tokens of the query and the virtual agent 214 processes 20% of the tokens of the query.

The GUI 900 can be displayed on any display of a computing device. Further, the GUI 900 may include other inputs as well. In some embodiments, the GUI 900 includes inputs for types of queries that the virtual agent 208B processes and types of queries that the virtual agent 214 processes. In some embodiments, the GUI 900 displays associated costs with using the virtual agent 208B. In some embodiments, the virtual agent 208B can be selected. Once selected the GUI 900 can receive input to remove, disable, or delete the virtual agent 208B from the client device 104. In some embodiments, the virtual agent 208B can be exchanged for a different virtual agent associated with a different HNI.

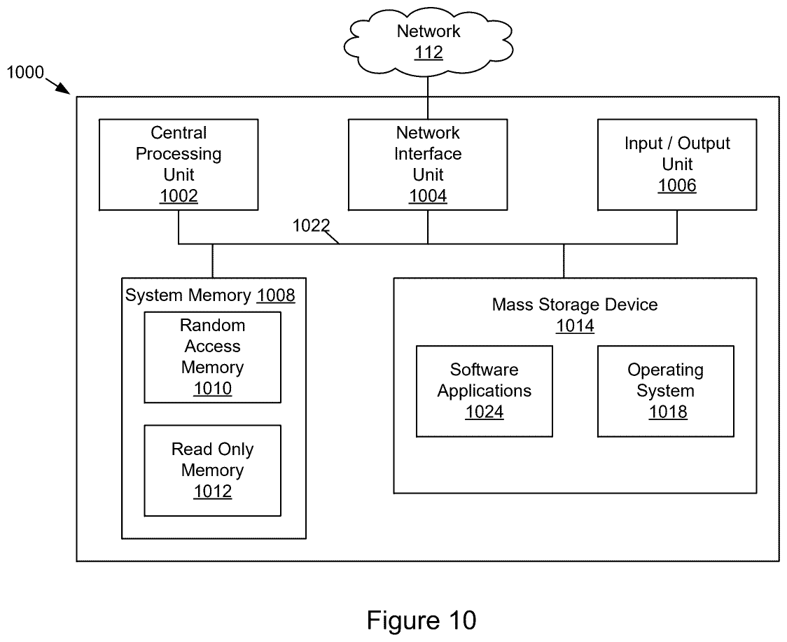

As illustrated in the embodiment of FIG. 10, an example device 1000, which provides the functionality described herein, can include at least one central processing unit (CPU) 1002, a system memory 1008, and a system bus 1022 that couples the system memory 1008 to the CPU 1002. The device 1000 can correspond to any of the computing devices in the system 100, such as the server device 110 or the client device 102. The system memory 1008 includes a random-access memory (RAM) 1010 and a read-only memory (ROM) 1012. A basic input/output system containing the basic routines that help transfer information between elements within the server device 110, such as during startup, is stored in the ROM 1012. The server device 110 further includes a mass storage device 1014. The mass storage device 1014 can store software instructions and data. A central processing unit, system memory, and mass storage device similar to that shown can also be included in the other computing devices disclosed herein.

The mass storage device 1014 is connected to the CPU 1002 through a mass storage controller (not shown) connected to the system bus 1022. The mass storage device 1014 and its associated computer-readable data storage media provide non-volatile, non-transitory storage for the server device 110. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, erasable programmable read-only memory (EPROM), electrically erasable programmable read-only memory (EEPROM), flash memory or other solid-state memory technology, compact disc read-only memory (CD-ROMs), digital versatile discs (DVDs), other optical storage media, magnetic cassettes, magnetic tape, magnetic disk storage or other magnetic storage devices, or any other medium which can be used to store the desired information and which can be accessed by the server device 110.

According to various embodiments of the invention, the server device 110 may operate in a networked environment using logical connections to remote network devices through network 112, such as a wireless network, the Internet, or another type of network. The server device 110 may connect to network 112 through a network interface unit 1004 connected to the system bus 1022. It should be appreciated that the network interface unit 1004 may also be utilized to connect to other types of networks and remote computing systems. The server device 110 also includes an input/output controller 1006 for receiving and processing input from a number of other devices, including a touch user interface display screen or another type of input device. Similarly, the input/output controller 1006 may provide output to a touch user interface display screen or other output devices.

As mentioned briefly above, the mass storage device 1014 and the RAM 1010 of the server device 110 can store software instructions and data. The software instructions include an operating system 1018 suitable for controlling the operation of the server device 110. The mass storage device 1014 and/or the RAM 1010 also store software instructions and applications 1024, that when executed by the CPU 1002, cause the server device 110 to provide the functionality of the server device 110 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method for managing virtual agents, the method comprising:
receiving first user data from a first user device associated with a first user account, the first user data including at least one of profile data, behavior data, and spending data;
providing the first user data to a large language model;
outputting, by the large language model, a first virtual agent corresponding to the first user account, the first virtual agent encoding behaviors associated with the first user account and based on the first user data;
receiving a request to provide the first virtual agent to a second user device;
receiving, from the second user device, an influence factor indicating a percentage of processing to be performed by the first virtual agent and a percentage of processing to be performed by a second virtual agent for queries received by the second user device; and
providing the first virtual agent to the second user device to process queries according to the influence factor.

2. The method of claim 1, wherein the influence factor indicates a first number of tokens that the first virtual agent processes and a second number of tokens that the second virtual agent processes.

3. The method of claim 1, further comprising providing a code to the second user device for scanning to access the first virtual agent.

4. The method of claim 1, further comprising:
receiving a second request to disable the first virtual agent; and
responsive to receiving the second request, deleting the first virtual agent from the second user device.

5. The method of claim 1, further comprising receiving, from the second user device, a first query that is processed by both the first virtual agent and the second virtual agent, and a second query that is processed by the second virtual agent and the not the first virtual agent.

6. The method of claim 1, further comprising:
receiving third user data from a third user device associated with a third user account;
providing the third user data to the large language model;
outputting, by the large language model, a third virtual agent corresponding to the third user account that encodes behaviors associated with the third user account; and
storing the third virtual agent in a virtual agent database, wherein the first virtual agent is also stored in the virtual agent database.

7. The method of claim 6, further comprising:
ranking the first virtual agent and the third virtual agent based on a number of requests for access to each of the first virtual agent and the third virtual agent; and
providing the ranking to the second user device.

8-14. (canceled)

15. A system for managing virtual agents, the system comprising:
a server device comprising:
one or more processors; and
one or more memory devices, the one or more memory devices including instructions that, when executed by the one or more processors, cause the server device to:
provide first user data associated with a first user account to a large language model;
generate, using the large language model, a first virtual agent corresponding to the first user account, the first virtual agent encoding behaviors associated with the first user account and based on the first user data; and
send the first virtual agent to another device responsive to receiving a request for access to the first virtual agent; and
a user device comprising:
second one or more processors; and
second one or more memory devices, the second one or more memory devices including second instructions that, when executed by the second one or more processors, cause the user device to:
receive the first virtual agent from the server device;
receive input indicating an influence factor indicating a percentage of processing to be performed by the first virtual agent and a percentage of processing to be performed by a second virtual agent for queries received from a user;
receive a query; and
process the query using the first virtual agent and the second virtual agent according to the influence factor.

16. The system of claim 15, wherein the second instructions include further instructions that, when executed by the second one or more processors, further cause the user device to:
receive a second query from second input;
determine, using the second virtual agent, a classification of the second query; and
responsive to a determination that the classification of the second query is an account query, process, using the second virtual agent, the second query without passing the second query to the first virtual agent.

17. The system of claim 16, wherein the second instructions include additional further instructions that, when executed by the second one or more processors, further cause the user device to:
receive a third query from third input;
determine, using the second virtual agent, a classification of the third query; and
responsive to a determination that the classification of the third query is an investment query, process, using the first virtual agent, the third query.

18. The system of claim 15, wherein, based on the influence factor, the first virtual agent processes a first number of tokens and the second virtual agent processes a second number of tokens, the second number being different from the first number.

19. The system of claim 15, wherein the instructions include further instructions that, when executed by the one or more processors, cause the server device to provide a code to the user device for scanning to access the first virtual agent.

20. The system of claim 15, wherein the second instructions include further instructions that, when executed by the second one or more processors, cause the user device to delete the first virtual agent from the user device.
